(19) United States
(12) Patent Application Publication
(10) Pub. No.: US 2024/0233285 A1
(43) Pub. Date: Jul. 11, 2024

(54) SYSTEM AND METHOD FOR USER ACTIONABLE VIRTUAL IMAGE GENERATION FOR AUGMENTED & VIRTUAL REALITY HEADSETS

(71) Applicant: Leidos, Inc., Reston, VA (US)

(72) Inventor: John Blake Gage, Herndon, VA (US)

(73) Assignee: Leidos, Inc., Reston, VA (US)

(21) Appl. No.: 18/403,880

(22) Filed: Jan. 4, 2024

Related U.S. Application Data
(60) Provisional application No. 63/478,629, filed on Jan. 5, 2023.

(51) Int. Cl. G06T 19/00; G06F 3/16; G06T 17/20; H04L 65/1089

(52) U.S. Cl. CPC G06T 19/006; G06F 3/167; G06T 17/20; H04L 65/1089

(57) ABSTRACT

A system for generating and providing an object in the field of view (FOV) of a user's augmented reality or virtual reality (AR/VR) session responsive to a verbal request for the object is described herein. An AR/VR communication component receives a verbal request for an object from the user and produces a text request for the object based on the verbal request. 2D image and 3D model generation components generate a 3D model of the object which is provided within the FOV of the user's AR/VR session.

### CROSS-REFERENCE TO RELATED APPLICATIONS

The present application claims priority to similarly titled Provisional Patent Application Serial No. 63/478,629, filed Jan. 5, 2023 which is incorporated herein by reference in its entirety.

### COMPUTER PROGRAM LISTING

An Appendix hereto includes the following computer program listing which is incorporated herein by reference: “LEID0041US_CodeAppendix.txt” created on Sep. 27, 2023, 584 KB.

### BACKGROUND OF THE EMBODIMENTS

### Field of the Embodiments

The embodiments are generally in the field of image generation and more specifically in the field of voice-controlled 3-D image generation during AR/VR (augmented reality/virtual reality) using machine learning techniques in tandem with an AR/VR headset's voice control.

### Description of Related Art

The fields of voice-to-text, text-to-image and 2D-to-3D image generation have separately benefitted from the revolutionary advances in the fields of machine learning and artificial intelligence (“AI”). In particular, the use of generative models has exploded in the field of text-to-2D image generation. A diffusion model is a type of generative model, which is an AI model that generates data that didn't exist before but is similar to the training data. For example, a diffusion model can be trained on multiple noisy versions of an original image, wherein a predetermined amount of noise is added to the original image in small increments. A diffusion model progressively removes noise, e.g., denoising, from the original data until it finally produces the original data without any noise. By showing the diffusion model the process of adding noise in small increments and then have it learn the opposite process of adding noise, i.e., subtracting noise in small increments, the trained model can take the noise as input and produce a slightly denoised image. The denoised image can then be fed back into the model to produce a denoised image twice, and so on, until eventually a complete, noise-free image is generated.

Notably, the Stable Diffusion model released in 2022 uses deep learning and diffusion techniques to generate detailed 2D images from text. The Stable Diffusion model supports the ability to generate new images from scratch through the use of a text prompt describing elements to be included or omitted from the output as described in Rombach et al., High-Resolution Image Synthesis with Latent Diffusion Models, published at arXiv:2112.10752v2 [cs.CV] 13 Apr. 2022 (hereafter “Rombach”).

In a product called Stable DreamFusion, a 2D-to-3D conversion AI/ML model builds on the Stable Diffusion concept to and employs mesh-generation to generate high quality 3D models from text, without the need for 3D data. As described in Poole et al., DreamFusion: Text-to-3D Using 2D Diffusion, arXiv:2209.14988v1 [cs.CV] 29 Sep. 2022, which is incorporated herein by reference in its entirety, Stable DreamFusion uses a loss derived from distillation of a 2D diffusion model. This loss is based on probability density distillation, minimizing the KL divergence between a family of Gaussian distribution with shared means based on the forward process of diffusion and the score functions learned by the pretrained diffusion model. The resulting Score Distillation Sampling (SDS) method enables sampling via optimization in differentiable image parameterizations. By combining SDS with a NeRF variant tailored to this 3D generation task, Stable DreamFusion is able to generates high-fidelity, coherent 3D objects and scenes for a diverse set of user-provided text prompts.

DeepFloyd IF, released in-part in 2023, is a modular cascaded pixel diffusion model (Stable Diffusion is a latent diffusion model) which has been incorporated into Stable DreamFusion as the 2D diffusion model in place of Stable Diffusion. DeepFloyd IF consists of several neural modules whose interactions in one architecture create synergy. The process starts with a base model that generates unique low-resolution samples, which is then up-sampled by successive super-resolution models to produce high-resolution images, e.g., a base model creates 64×64 pixel images based on frozen text prompts and super-resolution models, each designed to generate images with increasing resolution: 256×256 pixel and 1024×1024 pixel. The base and super-resolution models are diffusion models, where a Markov chain of steps is used to inject random noise into data before the process is reversed to generate new data samples from the noise. Unlike latent diffusion models (like Stable Diffusion), with DeepFloyd IF, diffusion is implemented on a pixel level, where latent representations are used. Additional description of DeepFloyd IF can be found in the Apr. 28, 2023 on-line article “Stability AI releases DeepFloyd IF, a powerful text-to-image model that can smartly integrate text into images” published by Stability.ai and incorporated herein by reference in its entirety.

### SUMMARY OF THE CLAIMED EMBODIMENTS

In a first embodiment described herein, a system for generating and providing an object in the field of view (FOV) of a user's augmented reality or virtual reality (AR/VR) session responsive to a verbal request for the object includes: an AR/VR communication component for receiving the verbal request for the object and producing a text request for the object based on the verbal request; an image generation component for receiving the text request for the object and generating a 2D image of the object; a model generation component for receiving the 2D image of the object and generating a 3D model of the object; and a communications component for providing the generated 3D model of the object within the FOV of the user's AR/VR session.

In a second embodiment described herein, a process for generating and providing an object in the field of view (FOV) of a user's augmented reality or virtual reality (AR/VR) session responsive to a verbal request for the object includes: receiving, by an AR/VR communication component, a verbal request for the object; producing, by the AR/VR communication component, a text request for the object based on the verbal request; receiving, by an image generation component, the text request for the object and generating a 2D image of the object; receiving, by a model generation component, the 2D image of the object and generating a 3D model of the object; and providing, by a communications component, the generated 3D model of the object within the FOV of the user's AR/VR session.

In a third embodiment described herein, a computer readable non-transitory medium comprising a plurality of executable programmatic instructions that, when executed in a computer system, enables generating and providing an object in the field of view (FOV) of a user's augmented reality or virtual reality (AR/VR) session responsive to a verbal request for the object, wherein the plurality of executable programmatic instructions, when execute include: produce a text request for the object based on the verbal request; generate a 2D image of the object from the text request; generate a 3D model of the object from the 2D image; and provide the generated 3D model of the object within the FOV of the user's AR/VR session.

### BRIEF DESCRIPTION OF THE FIGURES

Example embodiments will become more fully understood from the detailed description given herein below and the accompanying drawings, wherein like elements are represented by like reference characters, which are given by way of illustration only and thus are not limitative of the example embodiments herein.

FIG. 1 is a high level schematic of the system and processes of the multiple embodiments for generating 3D content within an AR/VR session prompted by user speech;

FIGS. 2A and 2B are exemplary prior art latent and pixel diffusion models;

FIG. 3 is an exemplary prior art image-to-3D mesh model; and

FIGS. 4A and 4B are exemplary data processing and communications microservice platforms for facilitating the 3D content generation of FIG. 1.

### DETAILED DESCRIPTION

The present specification is directed towards multiple embodiments. The following disclosure is provided in order to enable a person having ordinary skill in the art to practice the invention. Language used in this specification should not be interpreted as a general disavowal of any one specific embodiment or used to limit the claims beyond the meaning of the terms used therein. The general principles defined herein may be applied to other embodiments and applications without departing from the spirit and scope of the invention. Also, the terminology and phraseology used is for the purpose of describing exemplary embodiments and should not be considered limiting. Thus, the present invention is to be accorded the widest scope encompassing numerous alternatives, modifications and equivalents consistent with the principles and features disclosed. For purpose of clarity, details relating to technical material that is known in the technical fields related to the invention have not been described in detail so as not to unnecessarily obscure the present invention.

Some embodiments of this disclosure, illustrating all its features, will now be discussed in detail. The words “comprising,” “having,” “containing,” and “including,” and other forms thereof, are intended to be equivalent in meaning and be open-ended in that an item or items following any one of these words is not meant to be an exhaustive listing of such item or items, or meant to be limited to only the listed item or items. It should be noted herein that any feature or component described in association with a specific embodiment may be used and implemented with any other embodiment unless clearly indicated otherwise.

It must also be noted that as used herein and in the appended claims, the singular forms “a,” “an,” and “the” include plural references unless the context dictates otherwise. Although any systems and methods similar or equivalent to those described herein can be used in the practice or testing of embodiments of the present disclosure, the preferred, systems and methods are now described.

At a summary level, a user requests an object during an AR/VR session by speaking into an AR/VR headset. The headset voice controls receives the user's request, e.g., command, for the object which is processed through a series of distinct technologies in a microservice and delivered directly into the user's field of view (“FOV”) via an integrated client that is installed onto the AR/VR headset.

Multiple embodiments are described herein which integrate two distinct machine learning technologies: (1) A text-to-image diffusion model; and (2) A 2D-image-to-3D-wiremesh conversion model in order to generate requested content (3D objects) within an AR/VR session prompted by user speech. The Appendix hereto includes exemplary pseudocode for implementing the embodiments, including alternative mesh generator models. The programming language is Python.

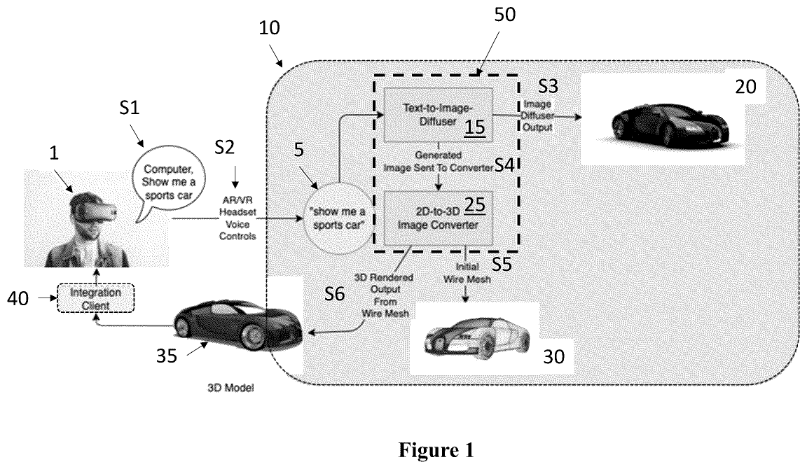

FIG. 1 is a high level schematic of the system and process. AR/VR user launches the AR/VR application 1 and speaks a request for content S1/5 which is picked up by AR/VR headset voice controls S2, converted to a text prompt 5, and sent to a microservice 10. The microservice receives the text element 5 at text-to-2D image diffuser 15 which generates image S3/20 and sends the generated image to a 2D-to-3D image converter S4/25. The 2D-to-3D image converter 25 generates an initial wire mesh image S5/30 and produces a 3D rendered model output from the wire mesh S6/35 which is integrated into the user's session via an AR/VR integration client 40. As discussed below and exemplified in the code in the Appendix certain components/processes have been consolidated into a product package 50.

The AR/VR headset voice controls, including voice-to-text prompt, may be implemented using products such as VoiceLab.ai's Conversational AI built on their ASR and NLP technologies. Other development kits include, for example, Meta's Voice SDK which is a collection of software modules that allow developers to integrate and build real-time voice call features into their own apps or platforms. Similarly, Microsoft's Speech API technologies, e.g., Cognitive Services Speech SDK and Azure AI Speech-to-text capabilities have been implemented in their mixed reality HoloLens headsets. Such voice control functionality for voice-driven gameplay and experiences is known to those skilled in the art.

The text-to-2D image generation component is modelled after currently-available open source technologies based on the revolutionary diffusion model concept. As described in Rombach, diffusion models are probabilistic models designed to learn a data distribution p(x) by gradually denoising a normally distributed variable. These text-to-2D image models form the base of the text-to-3D algorithms used in the preferred embodiments herein.

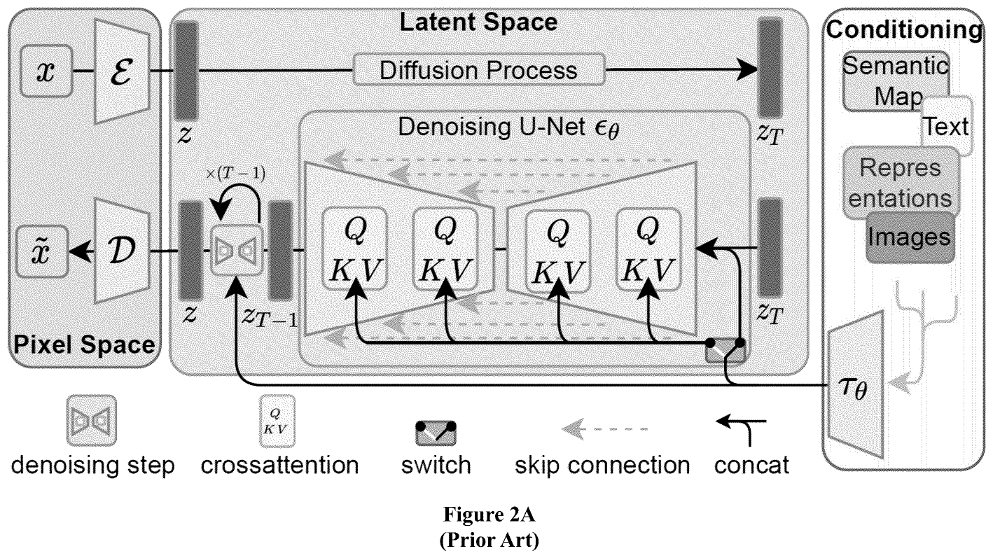

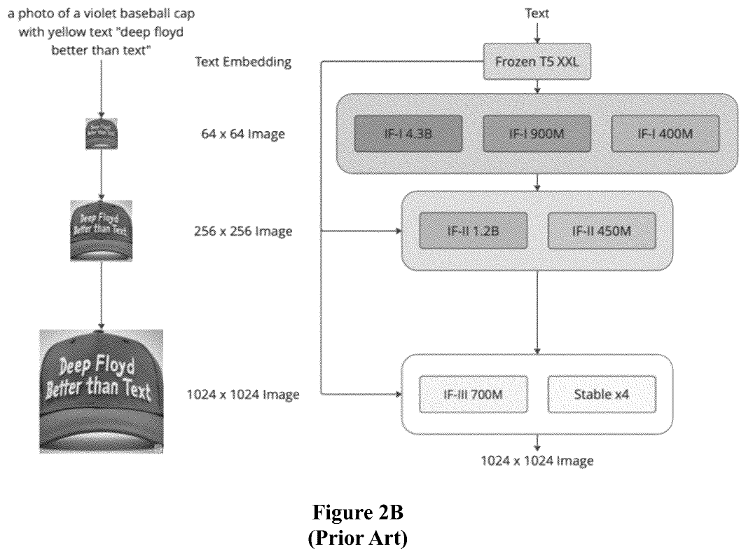

With reference to FIG. 1, in the preferred embodiment, a product 50 from Stability.ai called Stable DreamFusion is implemented for the text-to-3D image portion of the present process, which includes diffuser model 15 and 2D-to-3D converter 25. Further, in the preferred embodiment the diffusion model is the DeepFloyd IF model text-to-2D model referenced in the Background, which operates at a pixel level. In alternative embodiments, latent diffusion models such as Stable Diffusion may be used as the text-to-2D model. Exemplary latent and pixel diffusion models are represented in FIGS. 2A (Stable Diffusion) and FIG. 2B (DeepFloyd IF).

With respect to the latent Stable Diffusion model shown in FIG. 2a, as described in Rombach, the Stable Diffusion model is trained on, for example, the LAION-400M (CLIP-Filtered 400 Million Image-Text Pairs), wherein given an image [symbol] ∈ [symbol] ^{H×W×3} in RGB (pixel) space, the encoder ε encodes x into a latent representation z=ε(x), and the decoder [symbol] reconstructs the image from the latent, giving \tilde{x}= [symbol] (z)= [symbol] (ε(x)), where z ∈ [symbol] ^{h×w×c}. The Stable Diffusion model of FIG. 2a is an equally weighted [symbol] sequence of denoising autoencoders ϵ,θ(xₜ, t); t=1 . . . T, which are trained to predict a denoised variant of their input xₜ, where xₜ is a noisy version of the input x. The neural backbone ϵ_{θ}(o, t) is realized as a time-conditional U-Net denoising network based on the U-Net containing cross attention layers. (See, e.g., Ronneberger et al., U-Net: Convolutional Networks for Biomedical Image Segmentation, arXiv:1505.04597 (2015)). More specifically, the U-Net backbone is augmented to support modeling conditional distributions of the form p(z|y). This can be implemented with a conditional denoising autoencoder ϵ_{θ}(zₜ, t, y) to control the synthesis process through additional inputs y, e.g., semantic maps, additional image or text representation. To pre-process y from various modalities (such as language prompts) we introduce a domain specific encoder τ_{θ} that projects y to an intermediate representation τ_{θ}(y) ∈ R^{M×d}₉₆, which is then mapped to the intermediate layers of the UNet via a crossattention layer implementing Attention(Q, K, V)=softmax

$$( \frac{{QK}^{T}}{\sqrt{d}} ) \cdot V ,$$

$$with$$

$$Q = {W}_{Q}^{( i )} \cdot {φ}_{i} ( {𝓏}_{t} ) ,$$

$$K = {W}_{K}^{( i )} \cdot {τ}_{θ} ( y ) ,$$

$$V = {W}_{V}^{( i )} \cdot {τ}_{θ} ( y ) .$$

$$Here ,$$

$${φ}_{i} ( {𝓏}_{t} ) ∈ {ℝ}^{N \times {d}_{ϵ}^{i}}$$

denotes a (flattened) intermediate representation of the U-Net implementing ϵ_{θ} and

$${W}_{V}^{( i )} ∈ {ℝ}^{d \times {d}_{ϵ}^{i}} ,$$

$${W}_{Q}^{( i )} ∈ {ℝ}^{d \times {d}_{τ}}$$

$$\&$$

$${W}_{K}^{( i )} ∈ {ℝ}^{d \times {d}_{τ}}$$

are learnable projection matrices. Based on image-conditioning pairs, the conditional LDM is learned via

$${L}_{LDM} := {𝔼}_{ε ( x ) , y , ϵ ∼ 𝒩 ( 0 , 1 ) , t} [ {‖ ϵ - {ϵ}_{θ} ( {𝓏}_{t} , t , {τ}_{θ} ( y ) ) ‖}_{2}^{2} ] ,$$

where both ϵ_{θ} and ϵ_{θ} are jointly optimized.

The preferred DeepFloyd IF model of FIG. 2b utilizes the large language model T5-XXL-1.1 as a text encoder. The text prompt is passed through the frozen T5-XXL language model to convert it into a qualitative text representation. At a first stage, a base diffusion model transforms the qualitative text into a 64×64 image. There are three trained versions of the base model, each with different parameters: IF-I 400M, IF-I 900M and IF-I 4.3B. At the second stage, the stage one image is amplified, wherein two text-conditional super-resolution models (Efficient U-Net) are applied to the output of the base model. The first of these two text-conditional super-resolution models upscale the 64×64 image to a 256×256 image. Again, several versions of this model are available: IF-II 400M and IF-II 1.2B. And at stage 3, the second super-resolution diffusion model is applied to produce a vivid 1024×1024 image. A final as-yet released third stage model IF-III is expected to have 700M parameters. But the modular character of the IF model allows for use of other existing upscale models including the Stable Diffusion ×4 Upscaler.

Next, the rendered 2D image is converted to a 3D model (also referenced herein and in the art as a 3D mesh or 3D object and used interchangeably). In a preferred embodiment, the Stable DreamFusion algorithm (50 in FIG. 1) initializes a NeRF-like model with random weights, then repeatedly renders views of that NeRF from random camera positions and angles, using these renderings as the input to our score distillation loss function that wraps around the preferred diffusion model, DeepFloyd IF (FIG. 2b). Using gradient descent results in a 3D model (parameterized as a NeRF) that resembles the text. As is known to one skilled in the art, NeRF (Neural Radiance Field) is a technique for neural inverse rendering that consists of a volumetric raytracer and a multilayer perceptron (MLP). Rendering an image from a NeRF is done by casting a ray for each pixel from a camera's center of projection through the pixel's location in the image plane and out into the world. Sampled 3D points along each ray are then passed through an MLP, which produces a volumetric density and an RGB color. These densities and colors can be alpha-composited from the back of the ray towards the camera to produce the final rendered RGB value for the pixel. Exemplary code for implementing the text-to-3D algorithms described herein is disclosed in the Appendix.

An alternative process for converting the 2D image to a 3D model uses graph convolutions to deform a pre-defined generic input 3D mesh to form 3D structures as described in, for example, Wang, N. et al, Pixel2Mesh: Generating 3D Mesh Models from Single RGB Images, In: Ferrari, V., Hebert, M., Sminchisescu, C., Weiss, Y. (eds) Computer Vision—ECCV 2018. ECCV 2018 and further refined in Syed et al. Single Image 3D Reconstruction based on Conditional GAN, SICGAN (2020, July 19).

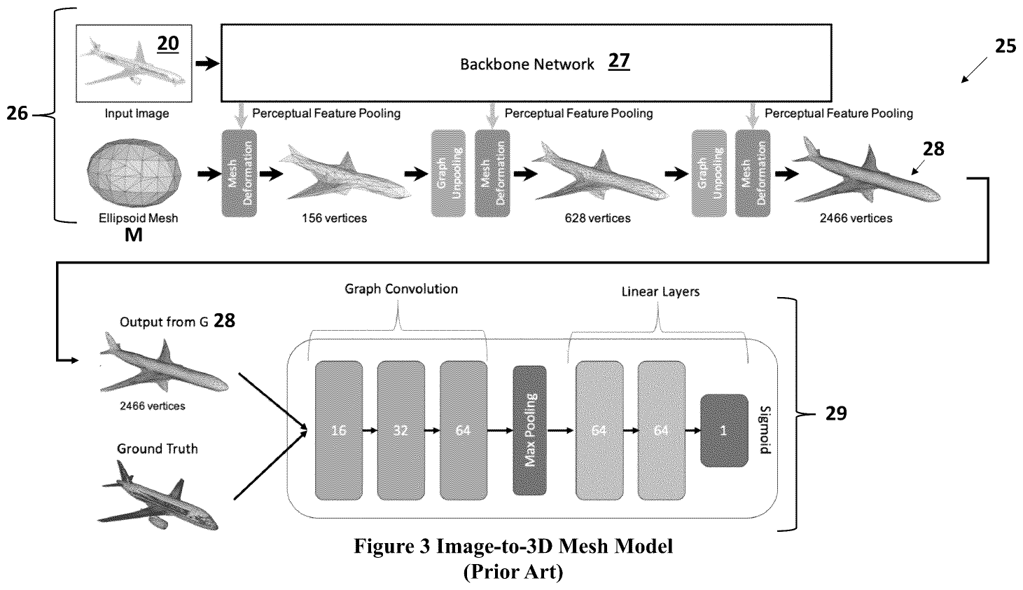

Referring to FIG. 3, the input 2-D image 20 (see FIG. 1) is input to Generator model 26 including backbone 27 which is a ResNet-50 model (ResNet-50 was selected because it outperforms the models selected for Pixel2Mesh and Mesh R-CNN). This backbone 27 generates an image 28 wherein the input mesh M is applied. Image 28 from the Generator model 26 is input to Discriminator 29 which is a shallow, seven-layer neural network that classifies whether the object (image 28) is real or fake (1 or 0, respectively). The Discriminator 29 may consist of three graph convolution layers with features of size 16, 32 and 64 followed by max pooling and three linear layer which condenses to a single value and a sigmoid activation for real vs fake prediction. Using a series of Generative Adversarial Networks (GAN) wherein the image is modelled as Markov random field, a conditional GAN is then used. This type of GAN essentially allows for the training of two types of models: the Generator and the Discriminator. The process uses a 3D-GAN described in, for example, Jiajun Wu, C. Z. Learning a Probabilistic Latent Space of Object Shapes via 3D Generative-Adversarial Modeling, Advances in Neural Information Processing Systems 29, (2016), which applies this GAN approach in learning latent 3D-space and thereby allows for the generation of 3D voxel models from these latent spaces by extending 2D convolutions into 3D convolutions.

Finally, the rendered 3D model (35 in FIG. 1) is incorporated into the requesting user's AR/VR session.

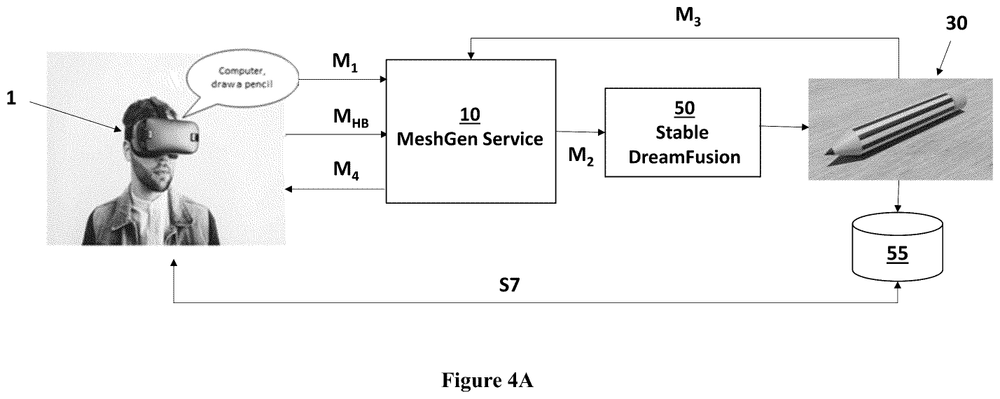

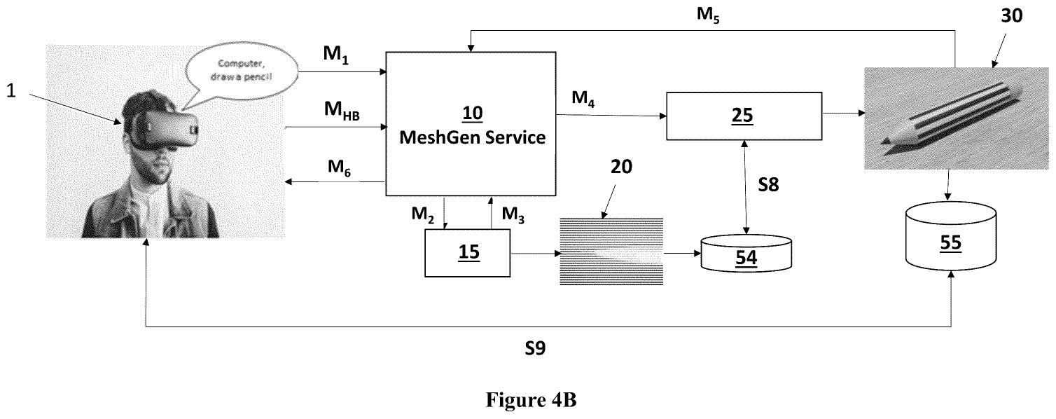

In a preferred embodiment, the data processing and communications platform supporting the overall processes of FIG. 1 is an asynchronous data processing framework built using open source technologies such as Flask and the attendant machine learning models. FIGS. 4A and 4B provide exemplary high level schematics of alternative configurations of the platform.

In FIG. 4A, after the AR/VR application 1 is launched from within the AR/VR head-set, when the user utters a command, e.g., “draw a pencil”, this speech is converted to text using, e.g., Microsoft Speech API technologies. The AR/VR application 1 then invokes a REST connection M₁ to a RESTful microservice 10 we've termed as the, “MeshGen service”. The microservice is written using the Flask framework which is a web application framework written in Python. Numerous tutorials and descriptions of the Flask framework are available in the public domain and known to and accessible by those skilled in the art. Upon receipt of the rendered text via REST connection message M₁, the service 10 loads the Stable DreamFusion service to generate 3D models (objects) based upon this text “prompt” M₂. The generated 3D objects are then stored to a directory 55 that is accessible by the AR/VR application 1 and the file path information for the requested and generated 3D object is provide to the microservice M₃ which communicates the 3D object's directory path to the AR/VR application M₄ for access and loading of the 3D object into the user's session via step S7. Web accessible 3D model directory and storage services such as those provided by TurboSquid may be used to store the generated 3D objects. As this processing is going on, the AR/VR application is continually asking the microservice if it is finished and this “heartbeat check” M_{HB} is seen by the user as an estimate of render time for the requested 3D object.

In an alternative embodiment shown in FIG. 4B, the platform facilitates additional coordination between a diffusion model, e.g., Stable Diffusion, for generating the 2D images from a text prompt and one or more mesh generator services, e.g. Pixel2Mesh, Point-E. etc., for generating the 3D object from the 2D image. The determination of which mesh generator is invoked by the service can be configured prior to running the service. Similar to the flow of FIG. 4A, the AR/VR application 1 invokes a REST connection M₁ to a RESTful microservice 10. Upon receipt of the rendered text via REST connection message M₁, the service 10 loads the diffusion model service 15 to generate 2D images from the text prompt M₂, stores the 2D images to a directory 54 and provides 2D image file directory location to the microservice M₃. Web accessible 2D image directory and storage services such as those provided by Unsplash may be used to store the generated 3D objects. Next, the microservice loads 3D object mesh generator service 25 and provides the 2D image file location within the directory M₄. Selected mesh generator service 25 accesses the 2D image file S8 and generates 3D models (objects). The generated 3D objects are then stored to a directory 55 that is accessible by the AR/VR application 1 and the file path information for the requested and generated 3D object is provide to the microservice M₅ which communicates the 3D object's directory path to the AR/VR application M₆ for access and loading of the 3D object into the user's session via step S9. Web accessible 3D model directory and storage services such as those provided by TurboSquid may be used to store the generated 3D objects. As this processing is going on, the AR/VR application is continually asking the microservice if it is finished and this “heartbeat check” M_{HB} is seen by the user as an estimate of render time for the requested 3D object.

One skilled in the art will appreciate that while components of the system may be separately identified herein, these components may share storage locations and processing resources or they may be separately located.

While the aspects described herein have been described in conjunction with the example aspects outlined above, various alternatives, modifications, variations, improvements, and/or substantial equivalents, whether known or that are or may be presently unforeseen, may become apparent to those having at least ordinary skill in the art. Accordingly, the example aspects, as set forth above, are intended to be illustrative, not limiting. Various changes may be made without departing from the spirit and scope of the disclosure. Therefore, the disclosure is intended to embrace all known or later-developed alternatives, modifications, variations, improvements, and/or substantial equivalents.

Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” All structural and functional equivalents to the elements of the various aspects described throughout this disclosure that are known or later come to be known to those of ordinary skill in the art are expressly incorporated herein by reference and are intended to be encompassed by the claims.

We claim:

1. A system for generating and providing an object in the field of view (FOV) of a user's augmented reality or virtual reality (AR/VR) session responsive to a verbal request for the object, the system comprising:
an AR/VR communication component for receiving the verbal request for the object and producing a text request for the object based on the verbal request;
an image generation component for receiving the text request for the object and generating a 2D image of the object;
a model generation component for receiving the 2D image of the object and generating a 3D model of the object; and
a communications component for providing the generated 3D model of the object within the FOV of the user's AR/VR session.

2. The system of claim 1, wherein the image generation component includes a generative model.

3. The system of claim 2, wherein the generative model is a diffusion model.

4. The system of claim 3, wherein the diffusion model is a latent diffusion model.

5. The system of claim 3, wherein the diffusion model is pixel diffusion model.

6. The system of claim 1, wherein the model generation component includes a NeRF model.

7. The system of claim 1, wherein the model generation component includes a conditional GAN.

8. The system of claim 1, wherein the communications component is an asynchronous microservice.

9. The system of claim 1, wherein the AR/VR communication component is a headset.

10. A process for generating and providing an object in the field of view (FOV) of a user's augmented reality or virtual reality (AR/VR) session responsive to a verbal request for the object, the process comprising:
receiving, by an AR/VR communication component, a verbal request for the object;
producing, by the AR/VR communication component, a text request for the object based on the verbal request;
receiving, by an image generation component, the text request for the object and generating a 2D image of the object;
receiving, by a model generation component, the 2D image of the object and generating a 3D model of the object; and
providing, by a communications component, the generated 3D model of the object within the FOV of the user's AR/VR session.

11. The process of claim 10, wherein generating a 2D image of the object includes application of a generative model to the generated 2D image.

12. The process of claim 11, wherein the generative model is a diffusion model.

13. The process of claim 12, wherein the diffusion model is a latent diffusion model.

14. The process of claim 12, wherein the diffusion model is pixel diffusion model.

15. The process of claim 10, wherein the model generation component includes a NeRF model.

16. The process of claim 10, wherein the model generation component includes a conditional GAN.

17. The process of claim 10, wherein the communications component is an asynchronous microservice.

18. The process of claim 10, further comprising:
storing, by the image generation component, the generated 2D image in a first database and communicating a file location for the generated 2D image in the first database to the communications component;
communicating, by the communications component, the file location of the 2D image to the model generation component;
accessing, by the model generation component, the 2D image, generating the 3D model and storing the generated 3D model in a second database and communicating a file location for the generated 3D model in the second database to the communications component; and
communicating, by the communications component, the 3D model file location to the AR/VR communication component for access thereby to provide the 3D model of the object in the field of view (FOV) of the user's augmented reality or virtual reality (AR/VR) session.

19. A computer readable non-transitory medium comprising a plurality of executable programmatic instructions that, when executed in a computer system, enables generating and providing an object in the field of view (FOV) of a user's augmented reality or virtual reality (AR/VR) session responsive to a verbal request for the object, wherein the plurality of executable programmatic instructions, when executed:
produce a text request for the object based on the verbal request;
generate a 2D image of the object from the text request;
generate a 3D model of the object from the 2D image; and
provide the generated 3D model of the object within the FOV of the user's AR/VR session.

20. The computer readable non-transitory medium of claim 19, wherein the 2D image of the object is generated by a diffusion model and the 3D model is generated by a model generation component, selected from the group consisting of a conditional GAN and a NeRF model.
